(19) United States
(12) Patent Application Publication
(10) Pub. No.: US 2015/0002650 A1
(43) Pub. Date: Jan. 1, 2015

(54) EYE GAZE DETECTING DEVICE AND EYE GAZE DETECTING METHOD

(71) Applicant: Kabushiki Kaisha Toshiba, Tokyo (JP)

(72) Inventors: Hiroshi Yoshimura, Saitama-shi (JP); Shinji Kuno, Ome-shi (JP); Yoshiyasu Itoh, Mitaka-shi (JP); Satoshi Takezaki, Ome-shi (JP)

(73) Assignee: Kabushiki Kaisha Toshiba, Tokyo (JP)

(21) Appl. No.: 14/218,683

(22) Filed: Mar. 18, 2014

(30) Foreign Application Priority Data
Jun. 28, 2013 (JP) 2013-137374

(51) Int. Cl. H04N 5/44; G06K 9/00; H04N 5/33; G01J 5/00; H04N 5/225

(52) U.S. Cl. CPC H04N 5/4403; G01J 5/0025; H04N 5/2252; H04N 5/33; G06K 9/00604; H04N 2005/4428
USPC 348/78

(57) ABSTRACT

According to one embodiment, an eye gaze detecting device includes a drive controller and a detector. The drive controller is configured to move an optical axis direction of an image pick-up module configured to pick up an image of an outside environment facing a display screen of a display by using a drive system. The detector is configured to detect an eye gaze direction of a viewer when image information picked up by the image pick-up module every time the drive controller moves the optical axis direction includes the face of the viewer.

### CROSS-REFERENCE TO RELATED APPLICATIONS

This application is based upon and claims the benefit of priority from Japanese Patent Application No. 2013-137374, filed Jun. 28, 2013, the entire contents of which are incorporated herein by reference.

### FIELD

Embodiments described herein relates generally to an eye gaze detecting device and an eye gaze detecting method.

### BACKGROUND

Conventionally, there has been proposed a technique that recognizes an eye gaze direction of a user to provide a service corresponding to the eye gaze direction. When the eye gaze direction of the user is detected with a monocular camera, resolution higher than that specified in a predetermined standard is required with respect to an image area of the user's eyes that is picked up with the camera.

In a PC or a tablet terminal to which the technique for recognizing the eye gaze direction is applied, the position of an operator with respect to the terminal is always constant and, at the same time, a distance between the operator and the screen of the terminal (an image pick-up module is provided in the vicinity of the screen) is short (within the range from 20 cm to 1 m, for example) and hence, it is easy to acquire the image area of the user's eyes that is picked up by the image pick-up module with a fixed angle of view at resolution higher than that specified in the predetermined standard.

However, in a video output device such as a television receiver, there exist many cases in which the user is distant from the screen by a predetermined distance or longer or the user does not view the screen squarely in many cases. Accordingly, it is difficult to apply the conventional technique for detecting the eye gaze direction to the video output device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating an example of a configuration of a television display device according to an embodiment;

FIG. 2 is an exemplary view illustrating an example of an environment in which the television display device in the embodiment is arranged, in the embodiment;

FIG. 3 is an exemplary view illustrating a configuration for detecting an eye gaze direction in the television display device in the embodiment;

FIG. 4 is an exemplary view illustrating an example of the horizontal swing motion of a swingable image pick-up module in the embodiment;

FIG. 5 is an exemplary view illustrating transition of a range picked up by the swingable image pick-up module controlled in a swinging manner by a drive controller in the embodiment;

FIG. 6 is an exemplary view illustrating an example of the face of a viewer detected with a detector in the embodiment;

FIG. 7 is an exemplary view illustrating a range picked up by an image pick-up module after controlling the swingable image pick-up module in a slightly swinging manner by the drive controller in the embodiment;

FIG. 8 is an exemplary view illustrating an example of partial image data obtained by cutting out a display area including the eyes of the viewer by the image pick-up module in the embodiment;

FIG. 9 is an exemplary view illustrating a concept of detecting the eye gaze direction by the detector in the embodiment; and

FIG. 10 is an exemplary flowchart of detection processing of the eye gaze direction of the viewer in the television display device in the embodiment.

### DETAILED DESCRIPTION

In general, according to one embodiment, an eye gaze detecting device comprises a drive controller and a detector. The drive controller is configured to move an optical axis direction of an image pick-up module configured to pick up an image of an outside environment facing a display screen of a display by using a drive system. The detector configured to detect an eye gaze direction of a viewer when image information picked up by the image pick-up module every time the drive controller moves the optical axis direction includes the face of the viewer.

In an embodiment described below, an example of a television display device to which an eye gaze direction detection device is applied is explained. Here, the present embodiment is not limited to the eye gaze direction detection device applied to the television display device, and another technique for detecting an eye gaze direction of a user whose eye gaze is directed toward a screen or the like may be used. For example, the technique may be applied to a projector or a display control device that controls the display on a display, and it may be possible to adopt the configuration in which a device separately provided to the outside of a television display device detects an eye gaze direction directed toward the television display device.

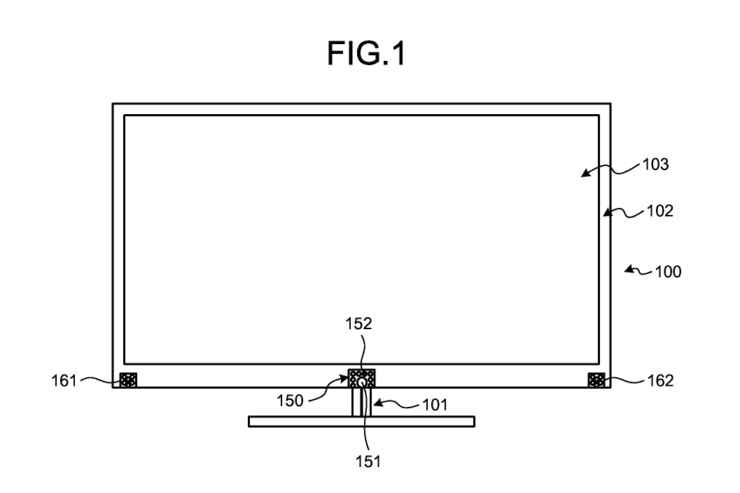

FIG. 1 is a view illustrating an example of a configuration of a television display device 100 according to the present embodiment. As illustrated in FIG. 1, the television display device 100 comprises a support 101 and a housing 102. The housing 102 houses therein at least a portion of a display 103.

Furthermore, in the present embodiment, the television display device 100 comprises a right-side IR emitter 161 and a left-side IR emitter 162 that emits infrared rays, and a swingable image pick-up module 150 on a lower side of the housing 102 thereof. The right-side IR emitter 161 and the left-side IR emitter 162 are spaced apart from the swingable image pick-up module 150 provided at the center of the lower side of the housing 102 by a predetermined distance (30 cm to 50 cm, for example) in the horizontal direction. In this manner, the television display device 100 in the present embodiment is provided with a plurality of IR emitters (the right-side IR emitter 161 and the left-side IR emitter 162) arranged on the surface of the housing 102 in the horizontal direction.

The swingable image pick-up module 150 is provided with an IR emitter 152 and an image pick-up module 151. The right-side IR emitter 161, the left-side IR emitter 162, and the IR emitter 152 provided to the swingable image pick-up module 150 emit infrared rays into the outside environment facing the display screen of the display 103 of the television display device 100.

In addition, the image pick-up module 151 provided to the swingable image pick-up module 150 picks up images of the outside environment facing the display screen of the display 103 of the television display device 100. The image pick-up module 151 in the present embodiment may be provided with a filter for cutting off visible light. To consider a case where the filter for cutting off the visible light is used, when the image pick-up module 151 picks up images in the outside environment with the use of the infrared rays emitted from the IR emitter 152, the right-side IR emitter 161, and the left-side IR emitter 162, it is possible to detect the eye gaze direction with high accuracy irrespective of the difference in environment such as a change in illuminance or wavelength (caused by the other illuminations, sunlight, or the like) at the time of television viewing.

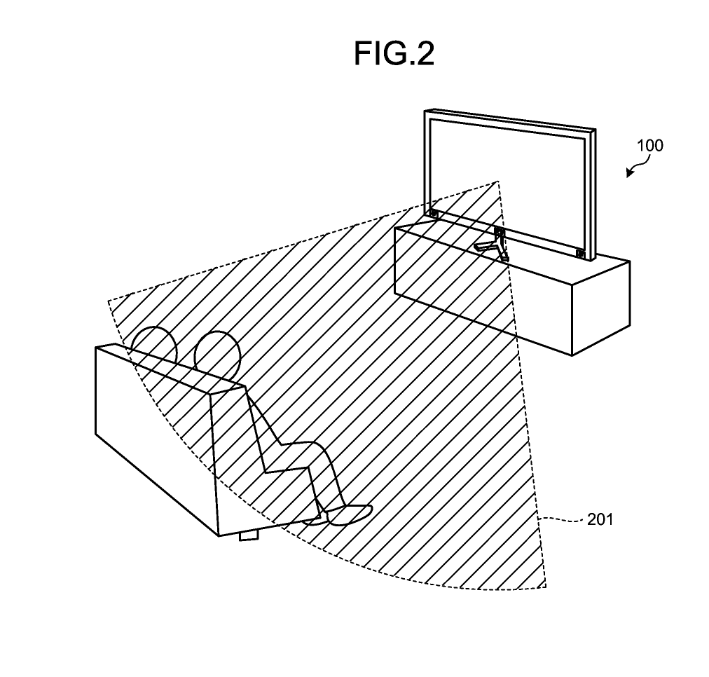

FIG. 2 is a view illustrating an example of the environment in which the television display device 100 in the present embodiment is arranged.

As is the case of a conventional PC or a handheld terminal (a tablet terminal, for example), when the position of an operator with respect to the terminal is always constant, the eye gaze direction can be detected with a camera sensor with a fixed angle of view.

In contrast, in the environment illustrated in FIG. 2, compared with a case in which a user uses a PC or a handheld terminal (a tablet terminal, for example) (a case in which a user faces the terminal in an opposed manner in a state that the user and the terminal are spaced apart from each other by a distance of several tens of centimeters), a plurality of viewers tend to exist or the distance between the viewer and the television display device 100 tends to be longer. Furthermore, the viewer moves while viewing a program or the viewer does not view squarely the television display device 100 in many cases. In the case of the television display device 100, such a difference in the environment makes it difficult to detect the eye gaze direction of the viewer with the camera sensor with a fixed angle of view.

Furthermore, in order to detect an eye gaze direction of a viewer, a property of a detection algorithm makes it necessary to use a high-resolution image pick-up module. It is necessary for the image pick-up module to use a sensor having several megapixels to several tens of megapixels. In addition, the property of the detection algorithm makes it necessary to transfer image data at a frame rate of at least 30 fps or higher and analyze the data.

However, the television display device 100 has no interface capable of capturing image data of several tens of megapixels at a frame rate of 30 fps or higher. Accordingly, in the television display device 100, unless a high-performance LSI is mounted on the television display device 100, it is necessary to lower the number of pixels per image data subject to detection or lower the frame rate. In this case, it is difficult to detect the eye gaze direction of a viewer with high accuracy.

In addition, it is necessary to allocate a certain level of resolution to the display area of the eyes of the viewer. That is, in the image data picked up when the distance between the television display device 100 and the viewer becomes longer, in order to allocate a certain level of resolution to the display area of the eyes of the viewer, it is necessary to mount a telephoto lens on the image pick-up module compared with the conventional PC or the handheld terminal.

In this manner, when the telephoto lens is mounted on the image pick-up module, an image area in the outside environment becomes small. However, the viewer may view video data displayed on the television display device 100 from various positions in the outside environment and hence, when the image pick-up module is a stationary, it is difficult to pick up an image of the viewer.

Consequently, in the present embodiment, the swingable image pick-up module 150 to which the image pick-up module 151 with the telephoto lens is provided is controllably driven by using a drive system so that the optical axis direction of the image pick-up module 151 moves. Accordingly, a viewer can be detected in a wide area of the outside environment (an area 201 in FIG. 2, for example). Furthermore, in the present embodiment, the telephoto lens is mounted on the image pick-up module 151 compared with conventional techniques and hence, the eye gaze direction of the viewer can be detected at a position apart from the television display device 100.

The image pick-up module 151 mounts thereon a general sensor having approximately 5 to 8 megapixels as a camera sensor. Furthermore, the image pick-up module 151 in the present embodiment uses a telephoto lens of an angle of view of the order of 10° as an example. The angle of view is set in the range where the whole face of the viewer can be properly imaged at the minimum viewing distance (1 m, for example) from the television display device 100. Here, although the present embodiment explains the telephoto lens of the angle of view of the order of 10° as an example, the present embodiment is not limited to this example and a telephoto lens of an appropriate angle of view may be used depending on the manner of application and other factors.

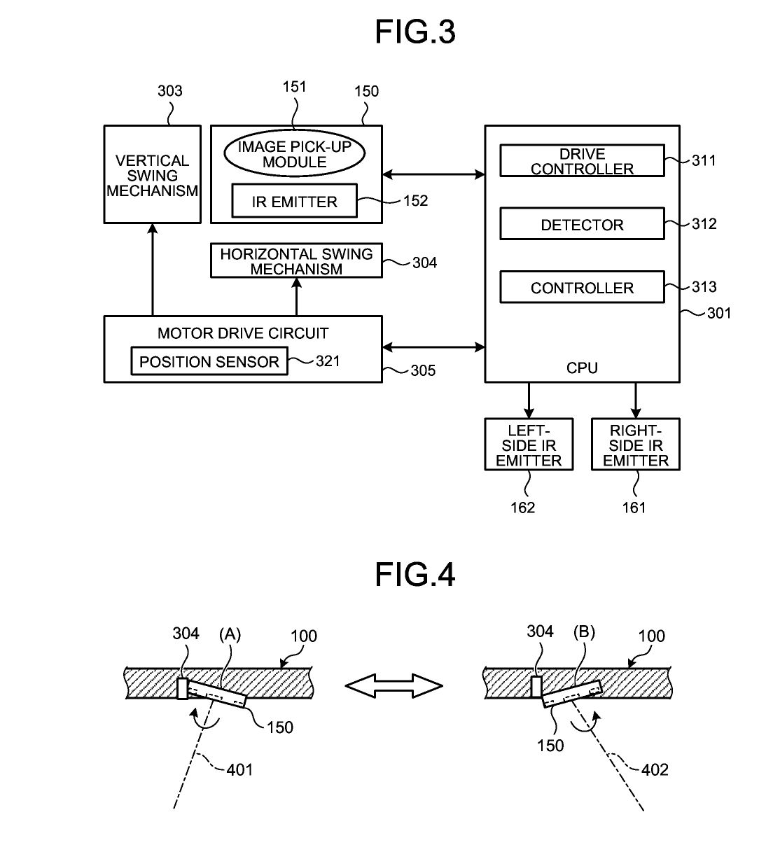

FIG. 3 is a view illustrating a configuration for detecting an eye gaze direction in the television display device 100 in the present embodiment. As illustrated in FIG. 3, the television display device 100 comprises a CPU 301, the swingable image pick-up module 150, the right-side IR emitter 161, the left-side IR emitter 162, a vertical swing mechanism 303, a horizontal swing mechanism 304, and a motor drive circuit 305.

The motor drive circuit 305 comprises a position sensor 321 and controls the vertical swing mechanism 303 and the horizontal swing mechanism 304 in accordance with instructions from the CPU 301. Such configuration makes it possible to provide the swingable image pick-up module 150 configured to be controlled in a swinging manner independently with respect to the horizontal direction and the vertical direction thereof. Here, as a motor controlled by the motor drive circuit 305, a general motor such as a stepping motor or a DC motor can be used and the type of the motor is not limited. Here, the motor drive circuit 305 is capable of controlling the image pick-up module 150 in a swinging manner in such a swinging range that a viewing angle satisfies the condition of a viewable angle range guaranteed in the television display device 100.

The position sensor 321 detects the position of the swingable image pick-up module 150.

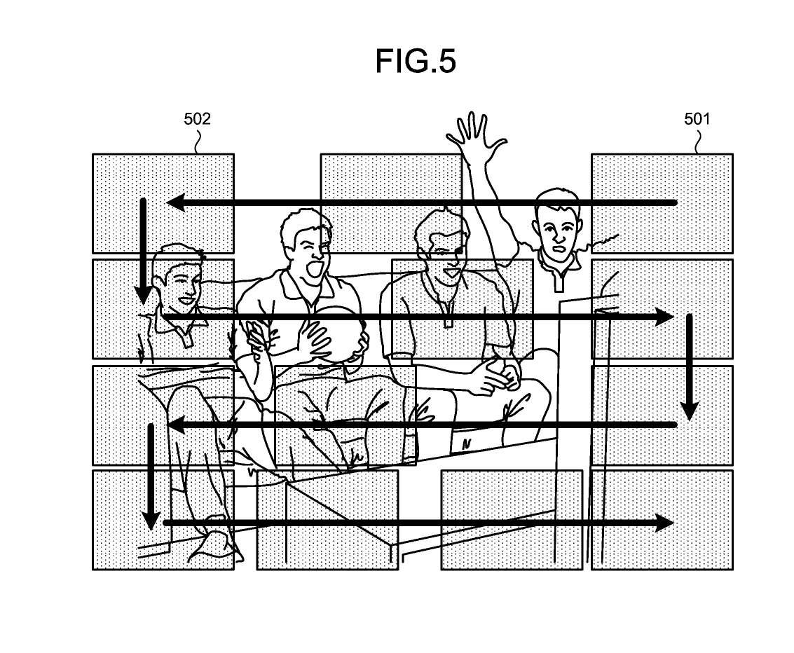

The horizontal swing mechanism 304 controls the swingable image pick-up module 150 in a swinging manner in the horizontal direction. FIG. 4 is a view illustrating an example of the horizontal swing motion of the swingable image pick-up module 150 in the embodiment. As illustrated in FIG. 4, the horizontal swing mechanism 304 controls the swingable image pick-up module 150 in a swinging manner in the horizontal direction thus controlling the swingable image pick-up module 150 in the horizontal direction in the range from an optical axis direction 401 indicated by a symbol (A) in FIG. 4 to an optical axis direction 402 indicated by a symbol (B) in FIG. 4. Here, a swinging angle is set to an appropriate angle depending on the actual use and other factors.

The vertical swing mechanism 303 controls the swingable image pick-up module 150 in a swinging manner in the vertical direction. Here, a method for controlling the swingable image pick-up module 150 in a swinging manner is same as the case of the horizontal swing mechanism 304.

The CPU 301 controls the television display device 100 as a whole. Furthermore, the CPU 301 reads a control program stored in a ROM that is not illustrated in the drawings thus achieving the operation of a drive controller 311, a detector 312, and a controller 313.

Furthermore, image data picked up by the image pick-up module 151 of the swingable image pick-up module 150 is transmitted to the CPU 301 via a transmission path such as a USB.

The drive controller 311 moves the swingable image pick-up module 150 in a swinging manner by using the motor drive circuit 305. In the present embodiment, the swingable image pick-up module 150 is moved in a swinging manner thus moving the optical axis of the image pick-up module 151 that picks up images in the outside environment facing the display screen of the display 103. In addition, the swingable image pick-up module 150 is moved in a swinging manner thus moving the IR emitter 152 together with the image pick-up module 151.

FIG. 5 is a view illustrating transition of the range picked up by the swingable image pick-up module 150 controlled in a swinging manner by the drive controller 311 in the embodiment. As illustrated in FIG. 5, the drive controller 311 controls the swingable image pick-up module 150 so that the image pick-up module 151 picks up images while moving in a swinging manner in the horizontal direction from an initial image pick-up range 501. Then, when the swingable image pick-up module 150 is moved to a position 502 of which the swingable image pick-up module 150 cannot be moved in a swinging manner in the horizontal direction ahead, the drive controller 311 controls the swingable image pick-up module 150 to move in a swinging manner in the vertical direction and controls the image pick-up module 151 so that the image pick-up module 151 picks up images while moving again in a swinging manner in the horizontal direction. The above-mentioned control is repeated thus detecting the faces of all viewers that exist in the outside environment in which the television display device 100 is viewable.

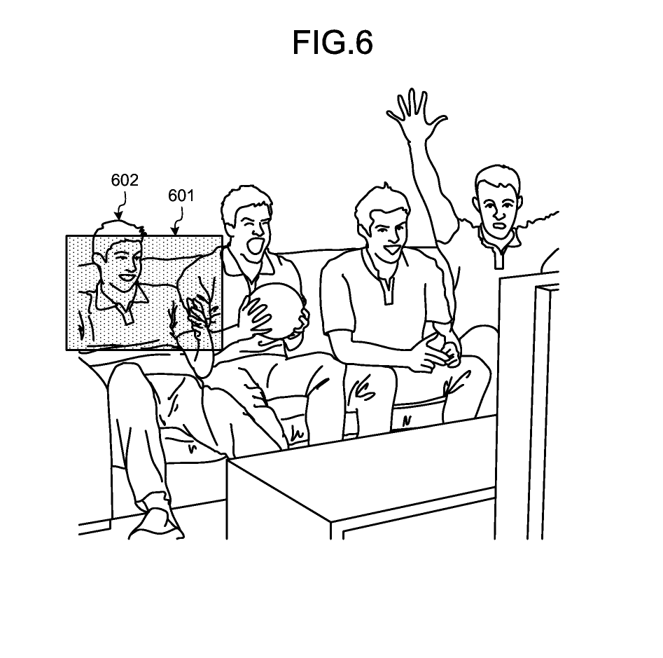

The detector 312 detects, every time the drive controller 311 moves the optical axis, the faces of the viewers from the image data picked up by the image pick-up module 151. FIG. 6 is a view illustrating an example of the face of a viewer detected with the detector 312. In the example illustrated in FIG. 6, when the image pick-up module 151 images the outside environment corresponding to a display area 601, the detector 312 detects the face of a viewer 602. Furthermore, the detector 312 detects, when detecting the face of a viewer, the eye gaze direction of the viewer.

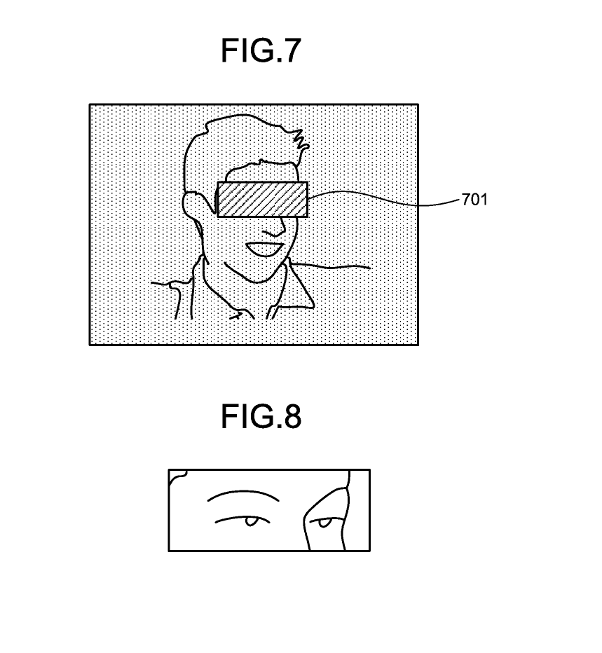

In the present embodiment, when the detector 312 detects the face of a viewer, the drive controller 311 controls the swingable image pick-up module 150 in a slightly swinging manner based on the result of detection by the detector 312 so that the eyes of the viewer are positioned at the center of the image data. FIG. 7 is a view illustrating a range picked up by an image pick-up module 151 after controlling the swingable image pick-up module 150 in a slightly swinging manner by the drive controller 311. As illustrated in FIG. 7, the drive controller 311 controls the swingable image pick-up module 150 in a swinging manner so that the eyes of the viewer are positioned at the center of the display area of the image data and hence, an image area 701 in which the eyes of the viewer are displayed can be prevented from being distorted due to a lens or the like provided to the image pick-up module 151.

Thereafter, the controller 313 controls the detector 312 so that the detector 312 can detect the eye gaze direction of a viewer. For example, when the detector 312 detects the eye gaze direction of a viewer, the controller 313 changes an IR emitter that emits infrared rays from among a plurality of IR emitters 152, 161, and 162. Based on the change of the IR emitter, the detector 312 detects the eye gaze direction of the viewer.

That is, in the present embodiment, the controller 313 changes the emission of infrared rays thus determining the position of reflecting the infrared rays from a light source reflected on each eye of a viewer. Furthermore, the detector 312 detects the eye gaze direction of the viewer based on the position of reflecting the infrared rays within the display area in which the eyes are detected out of the faces of the viewers detected in the image data.

In addition, the controller 313 instructs, when the detector 312 detects the face of a viewer, the image pick-up module 151 to transmit data of a partial image obtained by cutting out a display area including the eyes of the viewer from data of an image picked up.

FIG. 8 is a view illustrating an example of partial image data obtained by cutting out the display area including the eyes of the viewer by the image pick-up module 151. In the example illustrated in FIG. 8, only the display area including the eyes is cut out thus achieving a high frame rate compared with the case in which image data including the whole imaging area is transmitted.

Consequently, in the present embodiment, the controller 313 instructs, at the time of the starting the detection, the image pick-up module 151 to transmit image data of all pixels at a frame rate in the range of 1 to 5 fps (a first frame rate). Furthermore, the controller 313 instructs, when the detector 312 detects the face of a viewer, the image pick-up module 151 to transmit the partial image data obtained by cutting out the display area including the eyes of the viewer at a frame rate in the range of 30 to 60 fps (a second frame rate) that is higher than the first frame rate.

Consequently, the detector 312 detects the face of a viewer from the image data of all pixels that is transmitted at a frame rate in the range of 1 to 5 fps (the first frame rate) and detects the eye gaze direction of the viewer from the partial image data transmitted at a frame rate in the range of 30 to 60 fps (the second frame rate). Hence, transmission at a high frame rate can be achieved while maintaining the number of pixels of the display area in which eyes are displayed at a predetermined level or larger.

In this manner, the television display device 100 in the present embodiment has two modes as a transmission mode of an image; that is, a mode in which a whole image area picked up by the image pick-up module 151 is transmitted and a mode in which only an arbitrary rectangular area cut out from the whole image area is transmitted. A format of an image to be transmitted may be an uncompressed format such as YUV or a compressed format such as Motion JPEG or MPEG.

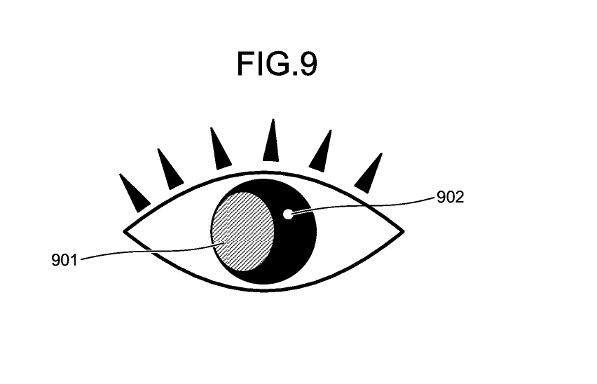

The detector 312 analyzes a partial image data transmitted at a frame rate in the range of 30 to 60 fps to detect the eye gaze direction of the viewer. FIG. 9 is a view illustrating a concept of detecting the eye gaze direction by the detector 312 in the present embodiment. The partial image data illustrated in FIG. 9 is capable of determining a position 902 of eyeball reflection (corneal reflection) of infrared rays emitted from the IR emitter 152. In the present embodiment, infrared rays are emitted thus determining the position 902 of the corneal reflection that squarely faces the television display device 100 without being affected by the eye gaze direction of the viewer. Furthermore, the detector 312 can determine an area 901 in which retinal reflection of infrared rays radiated from the IR emitter 152 occurs in a pupil, the retinal reflection being affected by the eye gaze direction. Furthermore, the detector 312 detects the eye gaze direction from an angle and a distance difference between the position 902 of the eyeball reflection and the area 901 in which the retinal reflection occurs in the pupil.

The television display device 100 is capable of being set so as to be operated, when there exist a plurality of viewers, by the eye gaze of only the viewer registered as an operator in advance. Accordingly, in the television display device 100 in the present embodiment, a feature amount of the face of the operator that is allowed to operate the television display device 100 by the eye gaze direction is registered in advance in a storage module that is not illustrated in the drawings.

When the detector 312 detects the face of a viewer from image data picked up by the image pick-up module 151, the controller 313 determines whether the face of the viewer that is detected corresponds to the feature amount of the face of the operator registered in the storage module. When the detector 312 determines that the face of the viewer corresponds to the feature quantity of the face of the operator, the television display device 100 performs various controls in accordance with the eye gaze direction of the viewer determined as the operator.

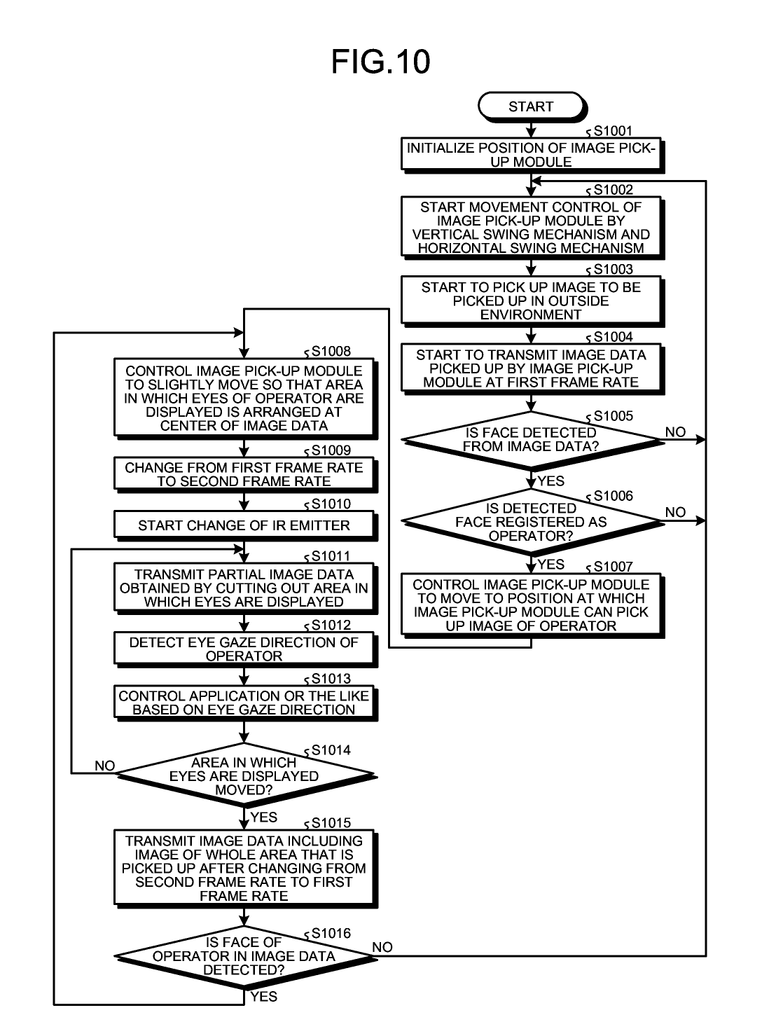

Next, detection processing of the eye gaze direction of a viewer in the television display device 100 in the present embodiment is explained. FIG. 10 is a flowchart of the above-mentioned processing in the television display device 100 in the present embodiment.

First of all, when the television display device 100 is started, the drive controller 311 initializes the position of the swingable image pick-up module 150 based on the position of the swingable image pick-up module 150 that is detected with the position sensor 321 (S1001). That is, in order to detect an eye gaze direction, after coordinates at which the swingable image pick-up module 150 is positioned in the horizontal direction and in the vertical direction are recognized by the position sensor 321, the drive controller 311 moves the swingable image pick-up module 150 to a detection start position (a position at which the image pick-up range 501 can be imaged in FIG. 5, for example). As an initialization method, when a stepping motor is used for a motor driven by the motor drive circuit 305, it is necessary to forcibly move the swingable image pick-up module 150 to an initialization position by using a photo interrupter or the like to recognize the position of the swingable image pick-up module 150. In addition, a mechanical component may be provided at a position within the moving range of the swingable image pick-up module 150 as a stopper so that a position at which the swingable image pick-up module 150 is consciously brought into contact with the stopper by being driven by the motor is set as the initialization position.

Next, the drive controller 311 controls the vertical swing mechanism 303 and the horizontal swing mechanism 304 via the motor drive circuit 305 to start the movement (swing) control of the swingable image pick-up module 150 (S1002). That is, the drive controller 311 starts the movement control of the swingable image pick-up module 150 so that the image pick-up module 151 can pick up images of viewers everywhere in the effective viewing range of the television display device 100.

The image pick-up module 151 provided to the swingable image pick-up module 150 starts to pick up images of viewers in the outside environment (S1003).

The image pick-up module 151 starts to transmit image data of all pixels that is picked up to the CPU 301 at a frame rate in the range of 1 to 5 fps (the first frame rate) (S1004). That is, at S1003, the image pick-up module 151 transmits a whole image in the image pick-up area at a low frame rate.

Next, the detector 312 detects the face of a viewer from the image data transmitted thereto (S1005). When the face has not been detected (No at S1005), the processing is started from S1002. Here, in detecting a face, a direction or the like of a face maybe detected. The detection of the face includes the detection of an approximate position of each eye. Here, as a method for detecting a face and eyes, methods conventionally used may be adopted, and their explanations are omitted.

On the other hand, when the detector 312 has detected the face of a viewer (Yes at S1005), the detector 312 determines whether the face detected is registered as an operator in reference to the storage module storing therein the feature amount of the face of the operator (S1006). When the detector 312 has determined that the face detected is not registered as the operator (No at S1006), the processing is started from S1002. Here, the determination of whether the detected face is registered as the operator may be performed only when the detector 312 has detected a plurality of faces.

When the detector 312 has determined that the detected face is registered as the operator (Yes at S1006), the drive controller 311 controls the swingable image pick-up module 150 to move to a position at which the image pick-up module 151 can pick up the image of the operator (S1007). In addition, the drive controller 311 controls the swingable image pick-up module 150 to slightly move so that an area in which the eyes of the operator are displayed is arranged at a center of the image data (S1008). Such the control of the swingable image pick-up module 150 for arranging the area in which the eyes of the operator are displayed at a center of the image data makes it possible to reduce the effect of the distortion in the peripheral portion of the lens in the technique of detecting the eye gaze direction that requires a high-precision image analysis.

The controller 313 requests the image pick-up module 151 to cut out image data to be transmitted and to change from the first frame rate to a frame rate in the range of 30 to 60 fps (the second frame rate) (S1009).

In addition, the controller 313 requests, in order to detect the eye gaze direction, the IR emitter 152, the right-side IR emitter 161, and the left-side IR emitter 162 to start the change of IR emitters to be used for emitting infrared rays (S1010). Here, methods for changing an IR emitter depend on the actual usage of the IR emitter and their explanations are omitted. Every time the IR emitter to be used for emitting infrared rays are changed from among of the IR emitter 152, the right-side IR emitter 161, or the left-side IR emitter 162, the position of eyeball reflection of infrared rays changes. Consequently, the detector 312 can recognize the difference between eyeball reflection of other ambient lights and eyeball reflection of infrared rays radiated from the IR emitter 152, the right-side IR emitter 161, and the left-side IR emitter 162. Accordingly, an eye gaze direction can be detected after removing the effect of the eyeball reflection of the other ambient lights thus improving the detection accuracy of the eye gaze direction.

The image pick-up module 151 starts to transmit partial image data obtained by cutting out an area in which eyes of an operator are displayed to the CPU 301 (S1011). Thereafter, the detector 312 detects the eye gaze direction of the operator from the partial image data transmitted at a frame rate in the range of 30 to 60 fps (the second frame rate) (S1012).

The CPU 301 controls applications or the like in accordance with the detected eye gaze direction (S1013). Items to be controlled in accordance with the eye gaze direction includes channel operations of the television display device 100, volume controls of sounds, power ON/OFF operations, and also, applications such as a browser incorporated in the television display device 100.

The detector 312 detects, in analyzing image data transmitted, the eye gaze direction of a viewer based on a eye gaze detection algorithm. The eye gaze direction is information capable of at least determining which position on the display screen of the television display device 100 is viewed by the viewer. That is, the detection of the eye gaze direction provides a user interface in which an interface device such as a remote controller is not used. In addition, a position pointed by the eye gaze direction is not limited to a position on the display screen of the television display device 100. On the assumption that the image area including eyes is picked up by the image pick-up module 151, a technique for detecting the eye gaze direction is a technique capable of determining which coordinates in the outside environment including the television display device 100 are viewed. For example, the eye gaze direction of an operator viewing an air conditioner or an illumination lamp may be detected. In this case, the CPU 301 of the television display device 100 may control a household appliance including the air conditioner or the illumination lamp.

Thereafter, the detector 312 determines whether the area in which eyes are displayed has moved from the transmitted partial image data (S1014). When the detector 312 determines that the area has not moved (No at S1014), the processing is started from S1011.

On the other hand, the detector 312 determines that the area in which the eyes are displayed has moved from the transmitted partial image data (Yes at S1014), the controller 313 requests the image pick-up module 151 to transmit image data of all pixels that is picked up and to change from the second frame rate to a frame rate in the range of 1 to 5 fps (the first frame rate) (S1015).

The detector 312 detects the face of an operator in the image data of all pixels that is transmitted (S1016). When the face of the operator has been detected (Yea at S1016), the processing is started from S1008. On the other hand, when the face of the operator has not been detected (No at S1016), the detector determines that the operator has moved, and the processing is started from S1002.

The above-mentioned processing make it possible to achieve the operation of the television display device 100 corresponding to the eye gaze direction of a viewer. Furthermore, the eye gaze detection technique using a monocular camera sensor in the present embodiment exposes a light source of an infrared wavelength to an operator, recognizes positions of and the angular difference between “the retinal reflection in the pupil” using a red-eye effect of a camera and the eyeball reflection of an infrared light spot, and analyzes image data from the camera sensor to detect the eye gaze. However, the present embodiment is not limited to such a method for detecting the eye gaze and a method using the other technique may be used.

In the eye gaze detection algorithm, in order to secure such an accuracy that the detector 312 can determine which position on the display screen of the television display device 100 is viewed, it is necessary to clearly image the eyeball portion of an operator in the image data picked up. Accordingly, in the present embodiment, infrared rays are emitted and the image pick-up module 151 is provided with a telephoto lens of an angle of view of the order of 10° and a sensor having approximately 5 to 8 megapixels. On the basis of the above, in the television display device 100, in order to achieve image capture with a high frame rate even when a CPU having low performance compared with a PC or the like is used, partial image data obtained by cutting out a display area including eyes is transmitted.

In addition, even when the outside environment in which the television display device 100 is viewable is large in scope, the swingable image pick-up module 150 is moved in a swinging manner in the horizontal direction and in the vertical direction thus perceiving and tracking viewers.

In this manner, in the eye gaze detection technique using the monocular camera, it is necessary to pick up the image of eyes at a high resolution and hence, it has been difficult to apply the technique to a television display device from which a viewer exists at a distance. However, the television display device 100 in the present embodiment is provided with the above-mentioned configuration and hence, even when in a viewing environment unique to a television set, the eye gaze of the viewer can be detected. This enables the eye gaze detection that can provide various interfaces without the use of hands, high-definition applications, and the eye-gaze operation of various home appliances other than the television display device 100.

In the television display device 100 in the present embodiment, infrared rays are emitted to detect the eye gaze direction of a viewer. That is, it has been conventionally necessary to consider various environments in which a television set is viewed. That is, there exist a case in which an illumination level is so high that the eye gaze direction can be detected and another case in which the illumination level is set low for viewing the television set. The low level illumination causes deterioration in S/N ratio because of insufficient sensor sensitivity, a residual image phenomenon because of a charge accumulation for increasing the sensitivity, or the like. In the worst case, a situation in which no object appears in an image picked up is made. In such a case, it is impossible to perform eye-gaze detection.

In the television display device 100 in the present embodiment, in order to perform eye-gaze detection, the direction of a face area and the direction of each eye are detected by image analysis. In addition, after the face is detected, an area in which the eyes are displayed is cut out. When the eye gaze is detected in image data of the display area in which the eyes are displayed, the number of pixels of the image data is small thus achieving the improvement of a real time property by the reduction of analysis processing.

In the present embodiment, the swingable image pick-up module 150 is driven in a swinging manner in the horizontal direction and in the vertical direction thus detecting whether a viewer exists in the large area (outside environment) in which the display screen of the television display device 100 is viewable. In addition, it is possible to follow a viewer when the viewer has moved.

In addition, in the present embodiment, when a plurality of viewers (faces) are detected, matching of the face detected with a face image registered in advance is performed to determine an operator by facial recognition. This can achieve the eye-gaze operation even when the faces of the plurality of viewers are detected.

In the present embodiment, in transmitting the partial image data obtained by cutting out the area in which eyes are displayed, the number of pixels of the partial image data is reduced compared with that of the image data of all pixels. Accordingly, even when a frame rate is improved, the number of pixels to be transmitted in transmitting the partial image data is reduced compared with the case in which the image data of all pixels is transmitted. Such configuration makes it possible to reduce a processing load of the CPU and hence, even when a CPU having a performance lower than the case of the PC or the like is incorporated in the television display device 100, it is possible to detect appropriately the eye gaze direction of a viewer.

In the present embodiment, the above-mentioned configuration makes it possible to apply the technique for detecting the eye gaze direction to the viewing of the television set. Furthermore, an object to be operated by the eye gaze direction is set to a home appliance (a set top box, an illumination, or an air conditioner, for example) other than the television display device 100 thus improving the convenience of viewers.

The present embodiment has explained the example in which a drive system drives the image pick-up module 151 and an optical system of the image pick-up module 151 is not provided with a zooming mechanism. Such configuration makes it possible to reduce costs. However, the present embodiment is not limited to the example in which the optical system of the image pick-up module 151 is not provided with the zooming mechanism. To consider a case where the optical system of the image pick-up module 151 is provided with the zooming mechanism, for example, in detecting the face of a viewer in the outside environment, the image of the viewer maybe picked up by using a zoom lens that is set to a wide angle side. After the face of the viewer has been detected, in detecting the eye gaze direction, the image of the viewer may be picked up by using the zoom lens that is set to a telescope side.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An eye gaze detecting device comprising:
a drive controller configured to move an optical axis direction of an image pick-up module configured to pick up an image of an outside environment facing a display screen of a display by using a drive system; and
a detector configured to detect an eye gaze direction of a viewer when image information picked up by the image pick-up module every time the drive controller moves the optical axis direction includes the face of the viewer.

2. The eye gaze detecting device of claim 1, wherein the detector is further configured to detect the face of the viewer from the image information, the eye gaze detecting device further comprising:
a controller configured to instruct the image pick-up module to transmit partial image information obtained by cutting out a display area including eyes of the viewer from the image information when the detector detects the face of the viewer.

3. The eye gaze detecting device of claim 2, wherein
the controller is further configured to instruct, when the image pick-up module transmits the image information at a first frame rate, the image pick-up module to transmit the partial image information at a second frame rate higher than the first frame rate under the condition that the detector detects the face of the viewer, and
the detector is configured to detect the face of the viewer from the image information transmitted at the first frame rate, and to detect the eye gaze direction of the viewer from the partial image information transmitted at the second frame rate.

4. The eye gaze detecting device of claim 1, further comprising:
an emitter configured to emit infrared rays into the outside environment, wherein
the detector is configured to detect the eye gaze direction of the viewer based on information on a position at which the infrared rays emitted by the emitter is reflected and within a display area in which the eyes of the viewer are detected in the image information.

5. The eye gaze detecting device of claim 4, wherein the drive controller is configured to move the emitter together with the image pick-up module by using the drive system.

6. The eye gaze detecting device of claim 4, wherein the emitter comprises a plurality of emitters provided in horizontal direction.

7. The eye gaze detecting device of claim 6, wherein the detector is configured to change an emitter to be used for emitting the infrared rays from among the emitters to detect the eye gaze direction of the viewer.

8. An eye gaze detecting method performed in a display control device configured control display on a display, the method comprising:
moving an optical axis direction of an image pick-up module configured to pick up an image of an outside environment facing a display screen of the display by using a drive system; and
detecting an eye gaze direction of a viewer when image information picked up by the image pick-up module every time the optical axis direction is moved at the moving includes the face of the viewer.
